(19) United States
(12) Patent Application Publication
(10) Pub. No.: US 2003/0161657 A1
(43) Pub. Date: Aug. 28, 2003

(54) DEVELOPING DEVICE, PROCESS CARTRIDGE, ELECTROPHOTOGRAPHIC IMAGE FORMING APPARATUS, AND DEVELOPER CONTAINER AND METHOD OF ASSEMBLING THE DEVELOPER CONTAINER

(75) Inventors: Akiyoshi Yokoi, Shizuoka (JP); Kazushi Watanabe, Shizuoka (JP); Toru Oguma, Shizuoka (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/094,605

(22) Filed: Mar. 12, 2002

(30) Foreign Application Priority Data
Feb. 27, 2002 (JP) 050657/2002(PAT.)

(51) Int. Cl. G03G 15/08

(52) U.S. Cl. 399/119; 399/262

(57) ABSTRACT

The configuration of a developer container unnecessary for being provided with a flange of a welding receiving portion at the time of the ultrasonic welding thereof increases the capacity of the developer container without enlarging a process cartridge or an apparatus main body. Flanges on an opposite surface of a developing frame are respectively touched to flanges formed on the upper part and the lower part on a wall surface, on which a developer feeding opening is formed, of a container frame constituting the developer container, and the flanges are welded at their connection portions by ultrasonic welding. Then, a flange of a lid frame is connected to a flange of the container frame on a welding plane by ultrasonic waves, and thereby a developer container, in which the container frame is connected with the developing frame with the developer feeding opening being put between the frames, is formed. In such a way, the welding plane is disposed at a position above both the connection portions on the outside of the connection portions, and thereby no dead spaces in which developer cannot be contained are formed.

### BACKGROUND OF THE INVENTION

1. field of the Invention

The present invention relates to a process cartridge being detachably mountable to the main body of an electrophotographic image forming apparatus, the electrophotographic image forming apparatus, a developing device, a developer container, and a method of assembling the developer container.

Hereupon, the electrophotographic image forming apparatus is an apparatus for forming an image on a recording medium using an electrophotographic image forming process. The electrophotographic image forming apparatus includes, for example, an electrophotographic copying machine, an electrophotographic printer (e.g. a laser beam printer, a light emitting diode (LED) printer, and the like), a facsimile machine, a word processor and the like.

Moreover, the process cartridge is a cartridge, into which an electrophotographic photosensitive member and at least developing means are integrally incorporated, and which is detachably mountable to the main body of an electrophotographic image forming apparatus. Incidentally, the process cartridge may include at least one of charging means for charging an electrophotographic photosensitive member and cleaning means for cleaning the electrophotographic photosensitive member besides the developing means.

2. Description of Related Art

Conventionally, an electrophotographic image forming apparatus has adopted a process cartridge system, in which an electrophotographic photosensitive member and process means acting on the electrophotographic photosensitive member are integrally formed into a cartridge detachably mountable to the main body of the electrophotographic image forming apparatus. Because, according to the process cartridge system, a user himself or herself can perform the maintenance of the apparatus without relying on a service person, the operability of the electrophotographic image forming apparatus could remarkably be improved. Accordingly, the process cartridge system is widely adopted in the electrophotographic image forming apparatus.

As shown in FIG. 15, a conventional process cartridge B includes a developing device unit 119 integrally formed by welding a developer container 114 and a developing frame 113 together. The developer container 114 contains developer and an agitating member 115 disposes in the developer container 114. The developing frame 113 holds developing means such as a developing blade 112a and a developing roller 111 as a developing member. The process cartridge B also includes a photosensitive member unit 120 composed of a photosensitive drum 109, cleaning means 117 including a cleaning blade 117a and a removed developer reservoir 117b, a charging roller 110, and the like, all being attached to a drum frame 118. The process cartridge B is made to be a cartridge by the combination of the developing device unit 119 and the photosensitive member unit 120 in the state of being swingable or integrated.

In such a process cartridge B, the developing device, or the developing device unit 119, is ordinarily composed as two-divided sections of the developing frame 113 supporting the developing roller 111 and the developing blade 112 as the developing members and the developer container 114 for containing developer therein. Moreover, ultrasonic-welding a container frame 122 and a lid frame 123 together at a welding plane U forms the developer container 114 in the shape of a container. After that, flanges 122a and 122b formed along a developer feeding opening of the developer container 114 (the container frame 122) and welding ribs 113a and 133b formed on the developing frame 113 are abutted against each other, and the flanges 122a and 122b and the welding ribs 113a and 133b are connected with each other by the ultrasonic welding at connection portions X and Y.

The ultrasonic welding of the developer container 114 and the developing frame 113 of the aforesaid conventional process cartridge B is performed by the following method as shown in FIG. 16. That is, the flanges 122a and 122b provided on the developer container 114 are supported on their under face by receiving jigs 170a and 170b, respectively. Then, the developing frame 113 is placed on the flanges 122a and 122b, and the developing frame 113 and the flanges 122a and 122b are welded by ultrasonic waves at the connection portions X and Y by the use of welding hones 171a and 171b, respectively, from the upper side of the developing frame 113. That is, the developing frame 113 and the developer container 114 are put between the receiving jigs 170a and 170b and the welding horns 171a and 171b, respectively, and the developing frame 113 and the developer container 114 are welded and fixed at the connection portions X and Y. Consequently, the developing frame 113 and the developer container 114 need the flanges.

As such, in the developing frame 113 and the developer container 114, the welding plane U is disposed between the two connection portions X and Y using the flanges. Therefore, spaces are required between the welding plane U and the two connection portions X and Y. These spaces are dead spaces in which developer cannot be contained. Consequently, the conventional process cartridge B has a problem such that the process cartridge B and the main body of the electrophotographic image forming apparatus become larger than their necessary sizes if the capacity of the developer container 14 in which developer can be contained is tried to be enlarged.

The present invention is a further development of the related art.

### SUMMARY OF THE INVENTION

An object of the present invention is to provide a developer container including a developer containing portion being improved in the efficiency of the developer containing capacity of the developer containing portion, a developing device using the developer container, a process cartridge using the developer container, a method of assembling the developer container, and an electrophotographic image forming apparatus.

Another object of the present invention is to provide a developer container including a developer containing portion the developer containing capacity of which is increased, a developing device using the developer container, a process cartridge using the developer container, a method of assembling the developer container, and an electrophotographic image forming apparatus.

A further object of the present invention is to provide a developer container capable of connecting its developer containing portion with its developing frame without forming a flange at least one portion, a developing device using the developer container, a process cartridge using the developer container, a method of assembling the developer container, and an electrophotographic image forming apparatus.

A still further object of the present invention is to provide a developer container capable of increasing its capacity not only without increasing a developing device or a process cartridge but also without increasing an electrophotographic image forming apparatus, the developing device using the developer container, the process cartridge using the developer container, a method of assembling the developer container, and the electrophotographic image forming apparatus.

A still further object of the present invention is to provide a developer container formed by connecting a developer containing portion and a developing frame on the side opposite to the developer containing side of the developer containing portion when the developer containing portion and the developing frame are connected together, a developing device using the developer container, a process cartridge using the developer container, a method of assembling the developer container, and an electrophotographic image forming apparatus.

According to the present invention, it becomes possible to increase the capacity of a developer container.

These and other objects, features and advantages of the present invention will become more apparent upon consideration of the following description of the preferred embodiments of the present invention taken in conjunction with the accompanying drawings.

### BRIEF DESCRIPTION OF THE DRAWINGS

FIG. 1 is a schematic view showing the entire configuration an electrophotographic image forming apparatus according to an embodiment of the present invention;

FIG. 2 is a sectional schematic view showing an embodiment of a process cartridge of the present invention;

FIG. 3 is a perspective view of the external appearance of the process cartridge of the embodiment of the invention;

FIG. 4 is a partially broken perspective view of a developer container of the process cartridge according to the embodiment of the invention;

FIG. 5 is a schematic sectional view showing a connecting state of the developing frame and the developer container, to which a seal member is attached, of the process cartridge according to the embodiment of the invention;

FIG. 6A is a sectional view for illustrating a connection portion of the container frame of the developer container and the developing frame of the process cartridge according to the embodiment of the invention, FIG. 6B and FIG. 6C are enlarged sectional views of connection portions X and Y of the container frame and the developing frame, respectively;

FIG. 7 is a perspective view showing a connecting surface of the developing frame of the process cartridge according to the embodiment of the invention;

FIG. 8 is a perspective view showing a state in that the seal member is to be attached to the container frame of the process cartridge according to the embodiment of the invention;

FIG. 9 is a perspective view showing a state in that the seal member has been attached to the container frame of the process cartridge according to the embodiment of the invention;

FIG. 10 is a perspective view for illustrating a method of drawing the seal member the process cartridge according to the embodiment of the invention;

FIG. 11 is an explanatory view showing a process of attaching the seal member to a developing device unit of the process cartridge according to the embodiment of the invention;

FIG. 12 is an explanatory view showing a process of connecting the developing frame and the container frame of the developing device unit of the process cartridge according to the embodiment of the invention;

FIG. 13 is an explanatory view showing a process of connecting a lid frame to the container frame of the developing device unit of the process cartridge according to the embodiment of the invention;

FIG. 14 is an explanatory view showing a process of connecting a developing frame and a container frame of a developing device unit of a process cartridge according to another embodiment of the invention;

FIG. 15 is a sectional schematic view showing a conventional process cartridge; and

FIG. 16 is a detail view showing connection portions of a developing frame and a container frame of the conventional process cartridge.

### DESCRIPTION OF THE PREFERRED EMBODIMENTS

Hereinafter, preferred embodiments of a developer container, a method of assembling the developer container, a developing device, a process cartridge and an electrophotographic image forming apparatus according to the present invention will be described with reference to the accompanying drawings.

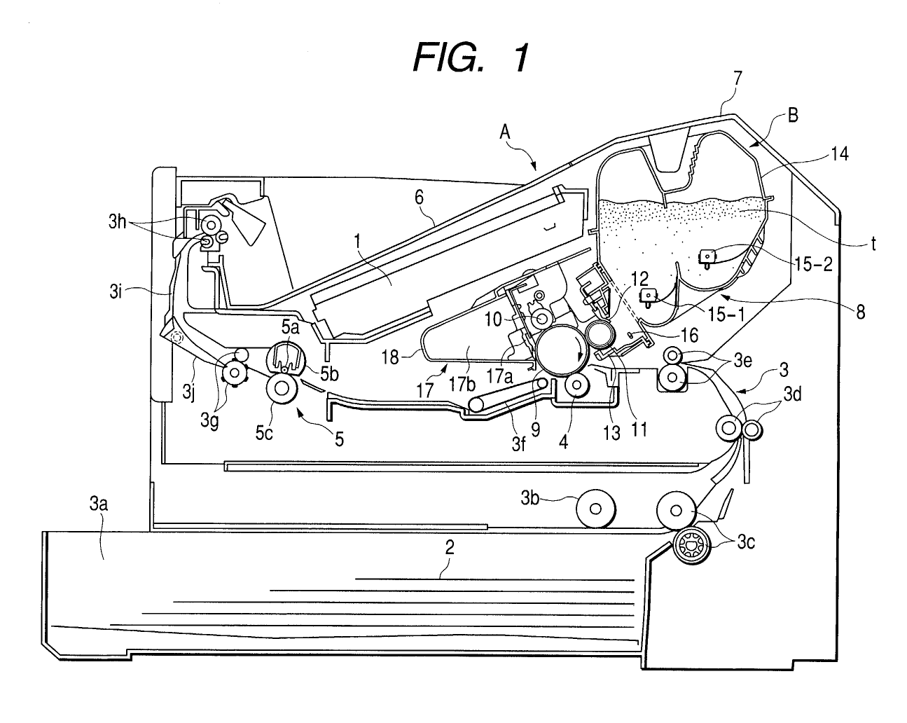

At first, an electrophotographic image forming apparatus detachably mounting a developing device or a process cartridge according to the present invention will be described with reference to FIGS. 1 to 10. Incidentally, a laser beam printer of an electrophotographic type is especially exemplified in the present embodiment.

An electrophotographic image forming apparatus (hereinafter simply referred to as an “image forming apparatus”) A includes a drum-shaped electrophotographic photosensitive member (hereinafter simply referred to as a “photosensitive drum”) 9. The photosensitive drum 9 is charged by a charging roller 10 as charging means, and then a laser beam corresponding to image information irradiates the photosensitive drum 9 from optical means 1 including a laser diode, a polygon mirror, a lens, a reflection mirror, and so on. Thereby, an electrostatic latent image corresponding to the image information is formed on the photosensitive drum 9. A developing device develops the electrostatic latent image with developer.

The developing device includes a developing roller 11 incorporating a magnet roller in the inside thereof, and a developing blade 12 as a developer amount regulating member for giving triboelectification charges to the developer on the surface of the developing roller 11 and for forming a developer layer having a predetermined thickness. A developing frame 13 holds the developing roller 11 and the developing blade 12. As described later, the developing frame 13 is welded to a developer container 14 for containing developer, and is made into a unitary body with the developer container 14 to constitute a developing device unit 19.

The developer container 14 is therein provided with agitating members 15-1 and 15-2 for agitating and feeding the developer to the developing frame 13. The developer in the developer container 14 is fed to the developing roller 11 in the developing frame 13 by the rotations of the agitating members 15-1 and 15-2. Moreover, the developing frame 13 is therein provided with a developer agitating member 16 in the vicinity of the developing roller 11. The agitating member 16 circulates the developer in the developing frame 13.

The developer t contained in the developer container 14 is fed to the developing frame 13 by the rotations of the agitating members 15-1 and 15-2 in the configuration described above. Then, the developer is agitated by the agitating member 16 in the developing frame 13 while being fed to the developing roller 11. And, the developer adheres to the surface of the developing roller 11 incorporating the magnet roller therein, and the developer is carried by the rotation of the developing roller 11. Then, the developer is given triboelectification charges by the developing blade 12, and a developer layer having a predetermined thickness is formed on the developing roller 11 and carried to a developing area of the photosensitive drum 9. The developer fed to the developing area is transferred to the electrostatic latent image on the photosensitive drum 9 to develop the electrostatic latent image. Incidentally, the developing roller 11 is connected with a developing bias circuit, which ordinarily applies a developing bias voltage composed of an alternative-current voltage superimposed on a direct-current voltage to the developing roller 11.

On the other hand, a recording medium 2 set in a cassette 3a is transported to a transferring position by a pickup roller 3b and pairs of transporting rollers 3c, 3d and 3e in synchronism with the formation of the developer image described above. At the transferring position, a transferring roller 4 as transferring means is disposed. By the application of a voltage to the transferring roller 4, the developer image on the photosensitive drum 9 is transferred to the recording medium 2.

The recording medium 2 on which the developer image has been transferred is transported to fixing means 5 through a transportation guide 3f. The fixing means 5 is provided with a driving roller 5c and a fixing roller 5b incorporating a heater 5a therein, and the fixing means 5 fixes the transferred developer image on the recording medium 2 by applying heat and pressure to the passing recording medium 2. After that, the recording medium 2 is delivered to a delivery tray 6 by pairs of delivery rollers 3g and 3h through a surface reverse path 3i. The delivery tray 6 is formed at the top surface of the image forming apparatus A. Incidentally, the recording medium 2 can also be delivered without passing through the surface reverse path 3i by the operation of a swingable flapper 3j. The pickup roller 3b, the pairs of the transporting rollers 3c, 3d and 3e, the transportation guide 3f and the pairs of the delivery rollers 3g and 3h, and so on constitute the transporting means 3 for the recording medium 2.

After the developer image has been transferred to the recording medium 2 by the transferring roller 4, the developer remaining on the photosensitive drum 9 is removed by cleaning means 17 so that the photosensitive drum 9 is ready for the next image forming process. The cleaning means 17 scrapes off the developer remaining on the photosensitive drum 9 with an elastic cleaning blade 17a provided in contact with the photosensitive drum 9, and the cleaning means 17 collects the removed developer to a removed developer reservoir 17b.

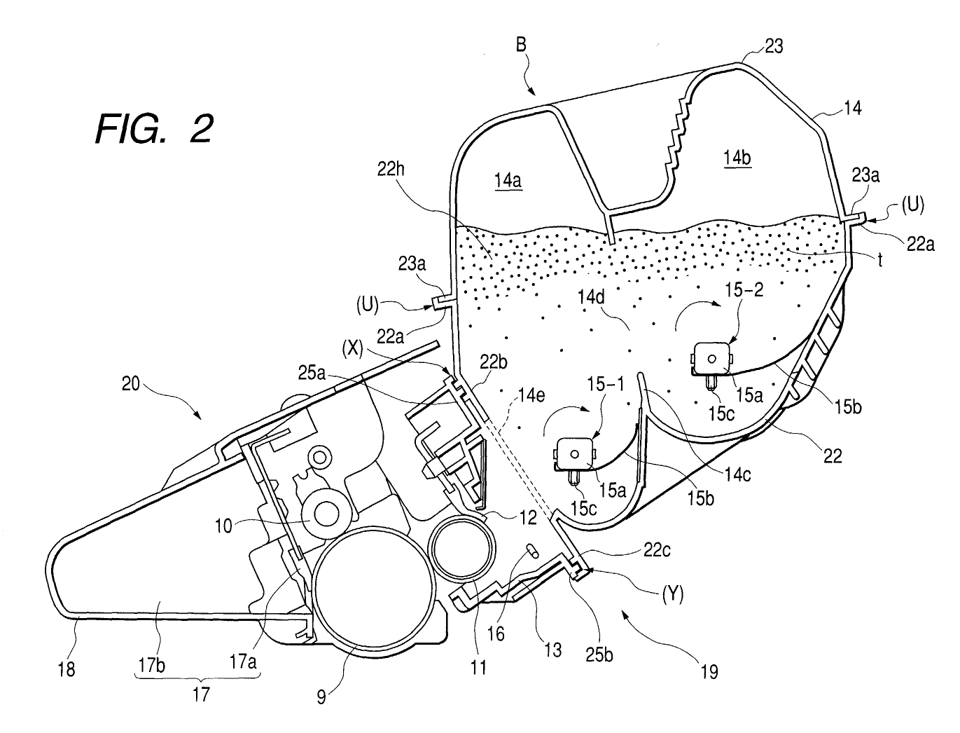

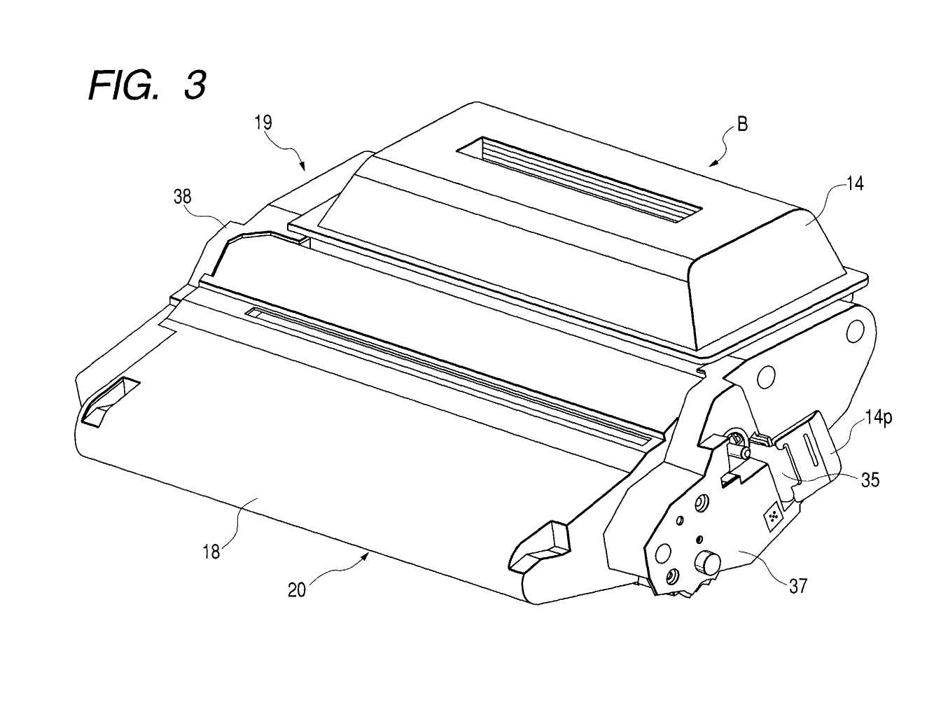

A process cartridge B detachably mountable to the image forming apparatus A configured as described above is configured as shown in FIG. 2 and FIG. 3 in detail. That is, the process cartridge (hereinafter simply referred to as a “cartridge”) B includes the developing device unit 19 composed of the developer container 14 and the developing frame 13, which are formed into a unitary body by welding or the like. The developing frame 13 holds a developing device having the developing roller 11, the developing blade 12 and the like. The cartridge B also includes a photosensitive member unit 20 composed of a drum frame 18, to which the photosensitive drum 9, the cleaning means 17 such as the cleaning blade 17a, the charging roller 10, and so on are attached. The developing device unit 19 and the photosensitive member unit 20 are flanked by a side cover (L) 37 on the left side end and a side cover (R) 38 on the right side end and connected integrally into a cartridge as shown in FIG. 3.

When the cartridge B is to be mounted to the apparatus main body of the image forming apparatus A, first a cartridge door 7 (see FIG. 1) provided on the apparatus main body of the image forming apparatus A is opened, and the cartridge B is detachably mounted on a cartridge mounting portion 8 provided in the apparatus main body. In the cartridge mounting portion 8, guide means (not shown) for guiding and leading guided means (not shown) provided on the outside surfaces of the opposed ends of the cartridge B, and positioning means (not shown) for positioning the cartridge B. Consequently, the cartridge door 7 (see FIG. 1) of the apparatus main body is opened and the cartridge B is inserted into the apparatus main body and moved along the guide means formed on inner surfaces of both the side walls of the apparatus main body. And then, the cartridge B is positioned by the positioning means of the cartridge mounting portion 8.

Next, the construction of the developer container 14 of the present embodiment will be described further in detail with reference to FIGS. 2, 3, 4, 5, 6A, 6B and 6C.

The developer container 14 is composed of a container frame 22 and a lid frame 23. The developer container 14 includes two containing portions 14a and 14b. At a position in which the bottom surfaces of the containing portions 14a and 14b meet with each other, a bottom partition portion 14c for regulating the height at which developer is drawn from the containing portion 14b is formed. The feeding of the developer from the containing portion 14b to the containing portion 14a is performed through an opening portion 14d formed above the partition portion 14c. Then, the agitating members 15-1 and 15-2 are disposed in the containing portions 14a and 14b, respectively. The agitation member 15-1 in the containing portion 14a is disposed at a relatively lower position than the agitating member 15-2. Thereby, the developer passed through the opening portion 14d can smoothly be carried using the falling of the developer caused by the self-weight of the developer.

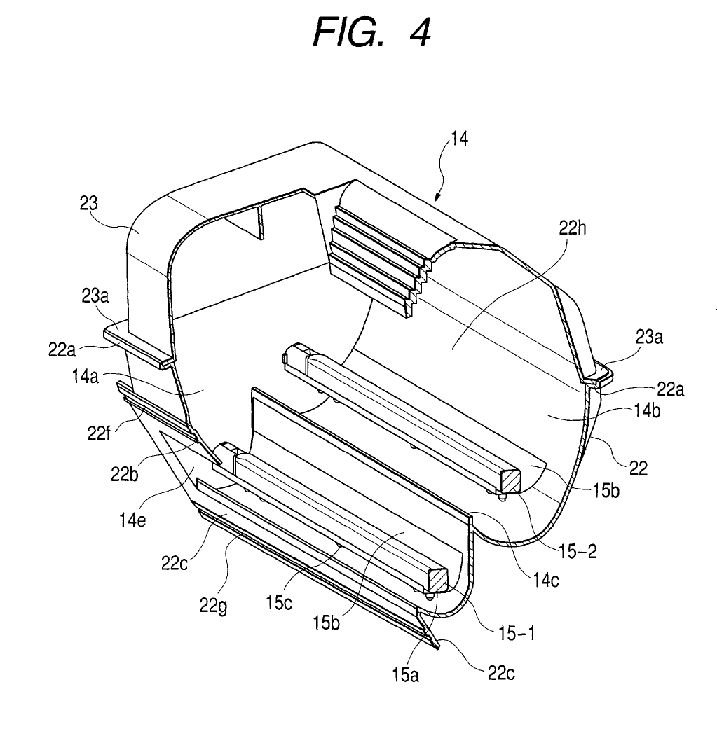

As shown in FIG. 2 and FIG. 4, each of the agitating members 15-1 and 15-2 is composed of a rotating bar member 15a, an elastic sheet 15b made from poly phenylene sulfide (PPS), and a pressing member 15c. The elastic sheet 15b is fixed to the rotating bar member 15a by means of screwing, gluing, welding, caulking with heat, or the like.

The agitating member 15-2 in the containing portion 14b rotates in the direction indicated by an arrow in FIG. 2 to agitate the developer in the containing portion 14b while feeding the developer into the containing portion 14a through the opening portion 14d. And, the agitating member 15-1 in the containing portion 14a rotates in the direction indicated by the arrow in FIG. 2 to agitate the developer in the containing portion 14a while feeding the developer into the developing frame 13 through the developer feeding opening 14e.

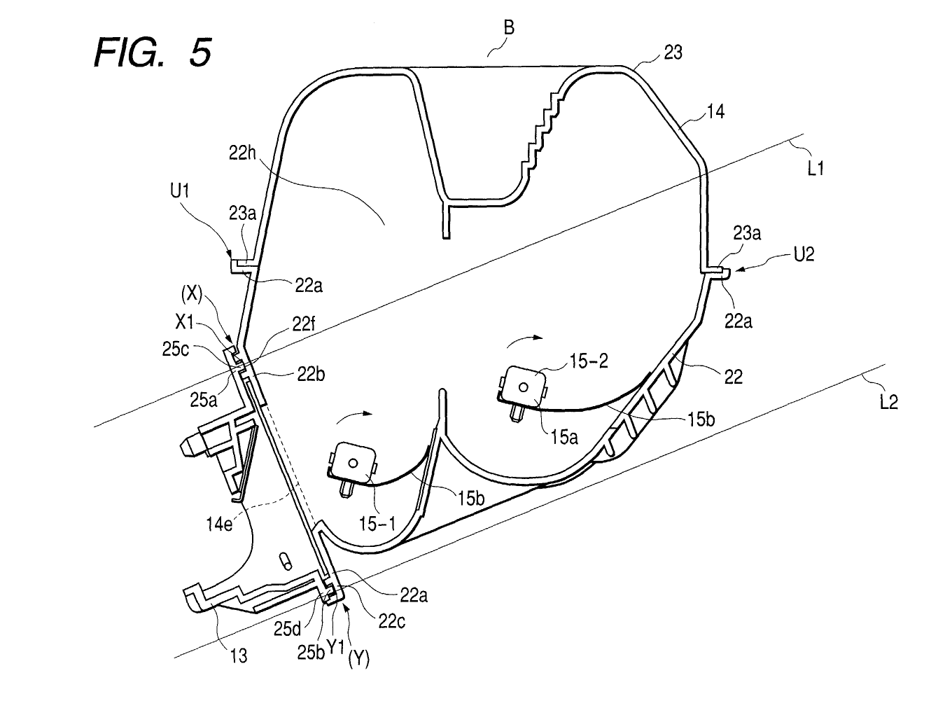

As shown in FIGS. 2, 4 and 5, the developer container 14 is composed of the container frame 22 in the lower part and the lid frame 23 in the upper part. The container frame 22 and the lid frame 23 are connected at a welding plane U. A developer feeding opening 14e is formed in a side wall portion of the container frame 22. An opening 22h to be closed by the lid frame 23 is formed on the upper part of the container frame 22. Then, a flange 22a, which projects to the outside around the opening 22h and is provided integrally with a surrounding rib (counter lock) around the opening 22h. Moreover, the lid frame 23 as the lid member covers the opening 22h of the container frame 22. A flange 23a corresponding to the flange 22a of the container frame 22 is projected outward from the periphery of the lid frame 23, and formed integrally with the lid frame 23. The flange 22a and the flange 23a are brought into contact with each other and welded so that the container frame 22 and the lid frame 23 are connected with each other. The connecting surface of the flange 22a and the flange 23a as a lid frame connection portion is the welding plane U. Accordingly, the flange 23a of the lid frame 23 is superimposed on the flange 22a of the container frame 22, and the welding plane U is subjected to the ultrasonic-welding so that the container frame 22 and the lid frame 23 are connected to each other by welding. Then, the frames 22 and 23 are integrated to form the developer container 14. As shown in FIG. 5, in the welding plane U, a lid frame connection portion located on one end side of the widthwise direction of the container frame 22 is designated by a reference character U1, and another lid frame connection portion located on the other end side is designated by a reference character U2.

As shown in FIGS. 2, 4 and 5, in a side wall portion, in which the developer feeding opening 14e is formed, of the container frame 22, a thread groove 22f extending in parallel to the edge portions of the developer feeding opening 14e on the upper and the lower sides thereof is formed on a wall surface 22b in the part above the developer feeding opening 14e. Moreover, a flange 22c is formed below the developer feeding opening 14e of the container frame 22. On the flange 22c, as shown in FIGS. 2, 4 and 5, a thread groove 22g extending in parallel to the edge portions of the developer feeding opening 14e similarly to the thread groove 22f.

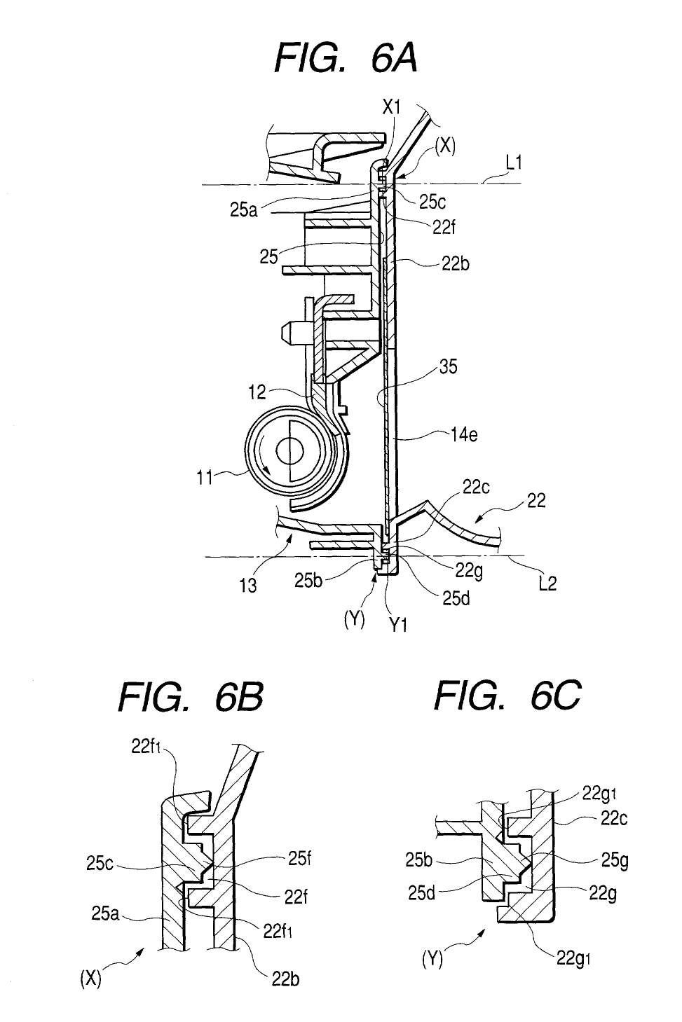

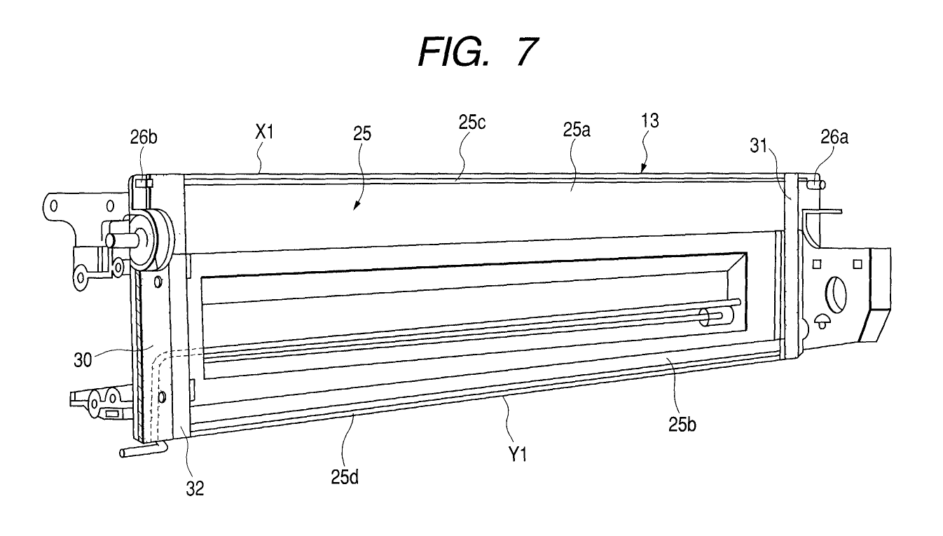

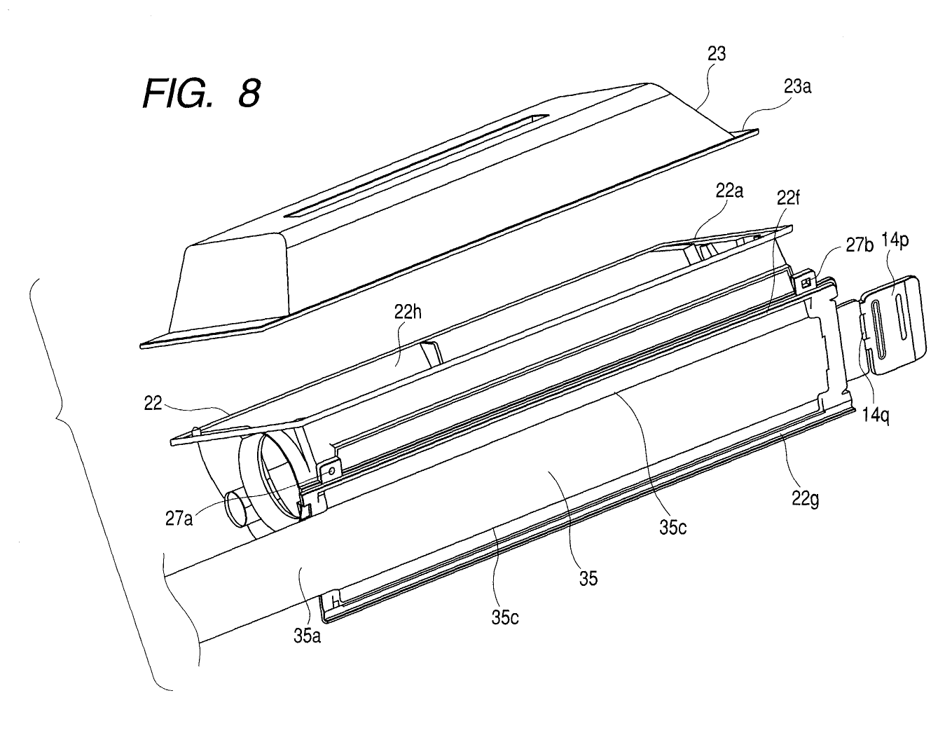

Furthermore, on an opposite surface 25, which is opposed to the container frame 22, of the developing frame 13, as shown in FIGS. 2 and 4-7, flanges 25a and 25b opposed to the wall surface 22b and the flange 22c of the container frame 22, respectively, are formed. Moreover, on the flanges 25a and 25b, protruded threads 25c and 25d extending in the lengthwise directions are respectively formed. The protruded thread 25c of the flange 25a is disposed to be opposed to the thread groove 22f formed on the wall surface 22b of the container frame 22 to be fitted into the thread groove 22f. And, the protruded thread 25d of the flange 25b is disposed to be opposed to the thread groove 22g formed on the flange 22c of the container frame 22 to be fitted into the thread groove 22g. Incidentally, protruded threads 25f and 25g (see FIG. 6B and FIG. 6C) having a triangular cross section for the ultrasonic welding are formed on the top surfaces of the protruded threads 25c and 25d, respectively. Incidentally, as shown in FIG. 7, on the opposite surface 25, which is opposed to the container frame 22, of the developing frame 13, a cylindrical dowel 26a and a rectangular dowel 26b, both being for positioning the developing frame 13, are formed on both end portions in the upper part of the opposite surface 25, respectively. A circular hole 27a and a rectangular hole 27b (see FIG. 8) disposed to be fitted onto the dowels 26a and 26b, respectively, are formed on the container frame 22 in correspondence with the dowels 26a and 26b for positioning. The circular hole 27a is fitted onto the dowel 26a closely. The rectangular hole 27b engages with the rectangular dowel 26b closely in the widthwise direction (or the vertical direction in FIGS. 7 and 8) and loosely in the lengthwise direction (or the horizontal direction in FIGS. 7 and 8). Incidentally, in FIG. 7, reference numerals 30 and 31 designate seal members. The seal members 30 and 31 are made of an elastic material such as a felt, and are respectively attached to the end portions in the lengthwise direction of the opposite surface 25, which is opposed to the container frame 22, of the developing frame 13. A reference numeral 32 designates a tape. The tape 32 is a synthetic resin film having a small friction coefficient. The tape 32 is attached on the inner portion of one side seal member 30.

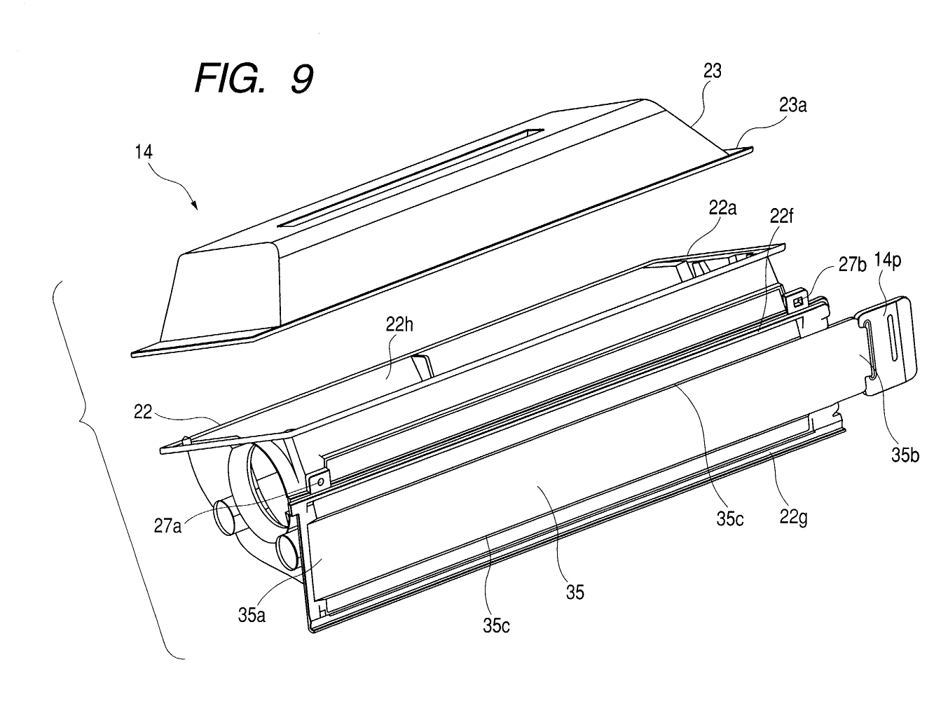

When the container frame 22 and the developing frame 13, both being configured as mentioned above, are connected and assembled, the wall surface 22b and the flange 22c of the container frame 22 are respectively abutted against the flanges 25a and 25b of the developing frame 13. At this time, the dowel 26a of the developing frame 13 is fitted into the hole 27a of the container frame 22, and the dowel 26b of the developing frame 13 is engaged with the hole 27b of the container frame 22. Consequently, the positioning dowels 26a and 26b of the developing frame 13 are respectively fitted into the positioning holes 27a and 27b of the container frame 22. Then the positioning of the developing frame 13 and the container frame 22 are performed. Moreover, the protruded threads 25c and 25d of the developing frame 13 are fitted into the thread grooves 22f and 22g of the container frame 22. In such a way, the container frame 22 and the developing frame 13 are brought into pressure contact with each other. Thereby, the seal members 30 and 31 disposed on both the end portions of the opposite surface 25 of the developing frame 13 are brought into contact with the container frame 22, and are compressed by the container frame 22. The thread grooves 22f and 22g of the container frame 22 and the protruded threads 25c and 25d of the developing frame 13 are fitted to each other, and are connected to each other by ultrasonic welding as it will be described later. Incidentally, a seal member 35 for covering the developer feeding opening 14e is attached to the peripheral portion of the developer feeding opening 14e by hot welding as it will be described later (see FIG. 8 and FIG. 9).

In the container frame 22 and the developing frame 13 being welded to each other by the ultrasonic welding as described above, two connection portions X and Y of the container frame 22 and the developer frame body 13 are respectively disposed at an upper position and a lower position on the same plane (at the positions at the upper peripheral portion and the lower peripheral portion of the developer feeding opening 14e) with the attaching portion of the aforesaid seal member 35 being put between the upper position and the lower position (see FIGS. 2, 5 and 6A-6C). The connection portion X is a first developing frame connection portion of the thread groove 22f on the wall surface 22b with the protruded thread 25c on the flange 25a. The connection portion Y is a second developing frame connection portion of the thread groove 22g on the flange 22c with the protruded thread 25d of the flange 25b. And, the lid frame connection portion U1 located on one end side in the widthwise direction of the container frame 22 is located on the outside of a plane L1 perpendicular to the developing frame connection portion X. The plane L1 passes through an outside end portion X1 in the widthwise direction of the developing frame connection portion X formed along the lengthwise direction of the developer feeding opening 14e on one end in the widthwise direction of the developer feeding opening 14e. Incidentally, the developing frame connection portion X is not located on the flange portion, but is located on the opposite side to the side of the container frame 22 on which developer is contained, namely on the back side of the portion in which the developer is contained.

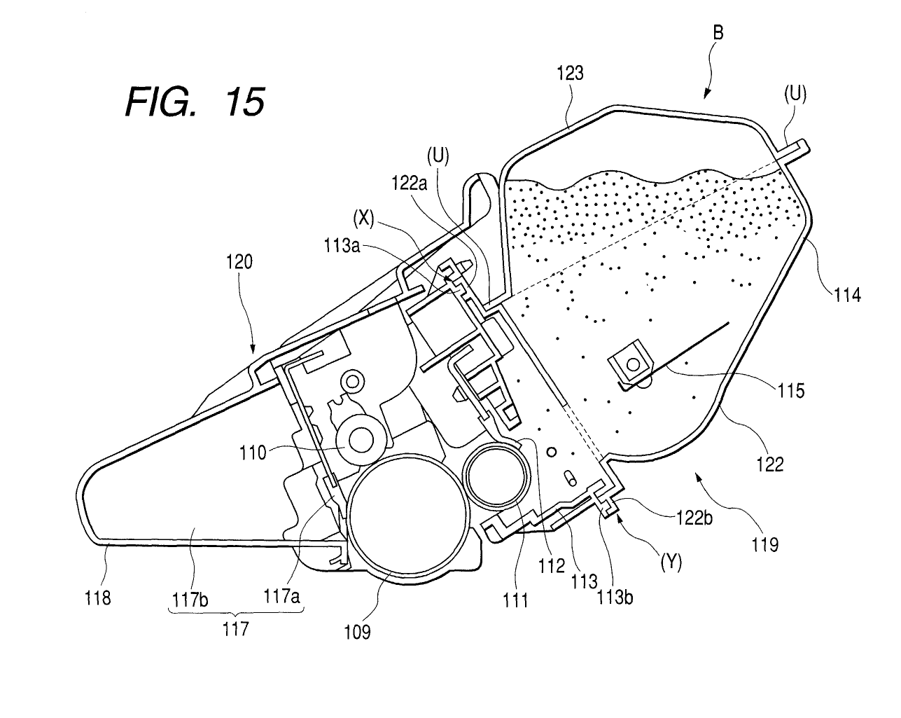

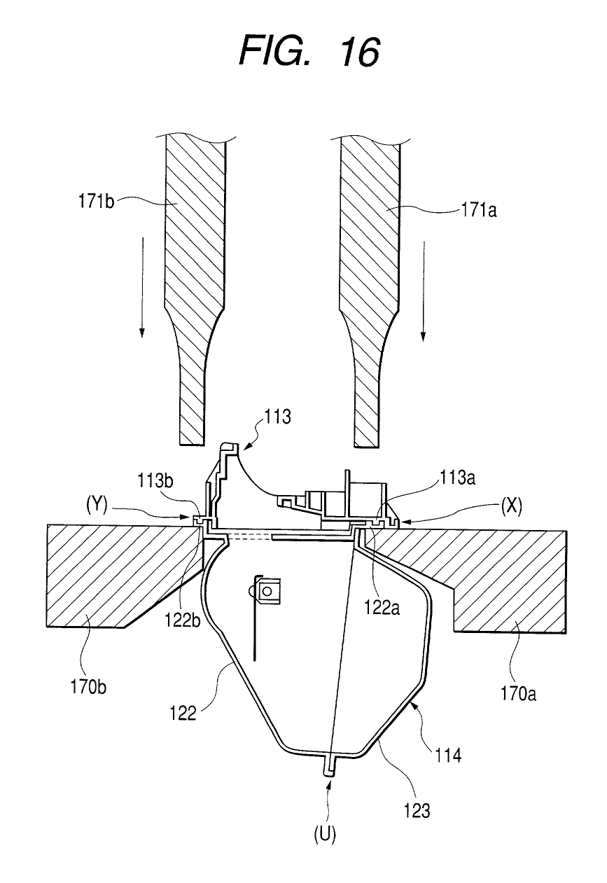

In the related art described above (see FIGS. 15 and 16), the welding plane U is disposed between the two connection portions X and Y of the container frame 122 and the developing frame 113, and spaces are formed between the welding plane U and the two connection portions X and Y. The spaces are the dead spaces in which developer cannot be contained. However, in the present embodiment, the lid frame connection portion U1 located on one end side in the widthwise direction of the container frame 22 is located on the outside of the plane L1 perpendicular to the developing frame connection portion X. The plane L1 passes through the outside end portion X1 (or an outside end portion X1 of the protruded thread 25c and the thread groove 22f constituting the developing frame connection portion X in the present embodiment; see FIGS. 5 and 6A) in the widthwise direction of the developing frame connection portion X formed along the lengthwise direction of the developer feeding opening 14e on one end in the widthwise direction of the developer feeding opening 14e. Then, as shown in FIG. 5, the lid frame connection portion U1 located on the one end in the widthwise direction of the container frame 22 and the lid frame 23 is connected at a position outside and above the connection portion X. Consequently, the dead space can be utilized as developer containing portion.

Incidentally, the outside of the perpendicular plane L1 means the opposite side to the center of the developer feeding opening 14e in the widthwise direction. Moreover, the word “above” means the above in the state that the developer container 14 is mounted in the apparatus main body. Besides, the perpendicular plane L1 is parallel to the connection portion X, i.e. the protruded thread 25c and the thread groove 22f. And the plane L1 is substantially perpendicular to the developing frame 13.

Incidentally, in the present embodiment, the configuration of the lid frame connection portion U1 is not applied to the lid frame connection portion U2. However, if the embodiment is also applied to the connection portion U2, the configuration of the connection portion U2 is as follows.

That is, the lid frame connection portion U2 located on the other end side of the widthwise direction of the container frame 22 is disposed outside a plane L2 perpendicular to the developing frame connection portion Y. The plane L2 passes through an outside end portion Y1 in the widthwise direction of the developing frame connection portion Y formed along the lengthwise direction of the developer feeding opening 14e on the other end in the widthwise direction of the developer feeding opening 14e.

In this case, the connection portion Y is not located on the flange portion, but is located on the opposite side to the side of the container frame 22 on which developer is contained, namely on the back side of the portion in which the developer is contained. Consequently, the arrangement and the configuration of the connection portion Y and the connection portion U2 are similar to those of the connection portion X and the connection portion U1 that are shown in FIGS. 5 and 6A. Accordingly, any drawing showing the arrangement and the configuration of the connection portion Y and the connection portion U2 is omitted.

Moreover, if the protruded threads 25f and 25g, which have the triangular cross sections and are welding ribs, of the developing frame 13 are formed on the container frame 22, the container frame 22 and the developing frame 13 can similarly be connected. Resins such as a polystyrene resin, an acrylonitrile-butadiene-styrene (ABS) copolymer resin, a polycarbonate resin, a polyethylene resin, a polypropylene resin, a poly phenylene oxide (PPO) resin, and the like can be used as the materials for forming the container frame 22, the lid frame 23 and the developing frame 13.

Next, the seal member 35 for covering the developer feeding opening 14e will be described in detail. The seal member 35 is composed of an aluminum (Al) film, polyethylene terephthalate (PET) films formed on the upper and lower sides of the Al film, and a hot welding layer (or a sealant layer) on the attachment surface of the seal member 35, all layers being laminated on top of one another. As shown in FIGS. 5, 6A and 8, the seal member 35 is attached to cover the developer feeding opening 14e of the developer container 14 (or the container frame 22). In the seal member 35, slits 35c extending along the lengthwise direction on each of the upper and the lower end portions of one layer of the laminated PET films are provided to make it easy to tear the seal member 35 when the developer feeding opening 14e is to be opened. An opening operation, which will be described later, tears the seal member 35 along the slits 35c to open the developer feeding opening 14e of the developer container 14.

As shown in FIG. 8 and FIG. 9, the seal member 35 has a length twice as long as that of the developer feeding opening 14e in the lengthwise direction or more. Almost the half of the length of the seal member 35 is attached to the peripheral portions of the developer feeding opening 14e. The other portion of the seal member 35, which is not attached, is folded back at one end portion 35a in the lengthwise direction of the developer feeding opening 14e to be put on the attached half portion, and then the end portion of the folded portion is drawn out from the end portion on the other side of the opening 14e to the outside thereof.

When the developer container 14 provided with the seal member 35 attached to the peripheral portions of the developer feeding opening 14e and the developing frame 13 are connected integrally with each other, as shown in FIG. 7, the seal member 35 is brought into contact with and urged against the seal member 30 such as a felt attached to the end portions in the lengthwise direction of the opposite surface 25, which is opposed to the container frame 22, of the developing frame 13, and then the seal member 35 is drawn out to the outside through between the developer container 14 (or the container frame 22) and the developing frame 13. Incidentally, the tape 32, which is made from a synthetic resin film and has a small friction coefficient, is attached on the surface of the seal member 30 on the inner side thereof. Moreover, the seal member 31 is attached to the end portion, opposed to the position where the seal member 30 is attached, of the opposite surface 25 in the lengthwise direction.

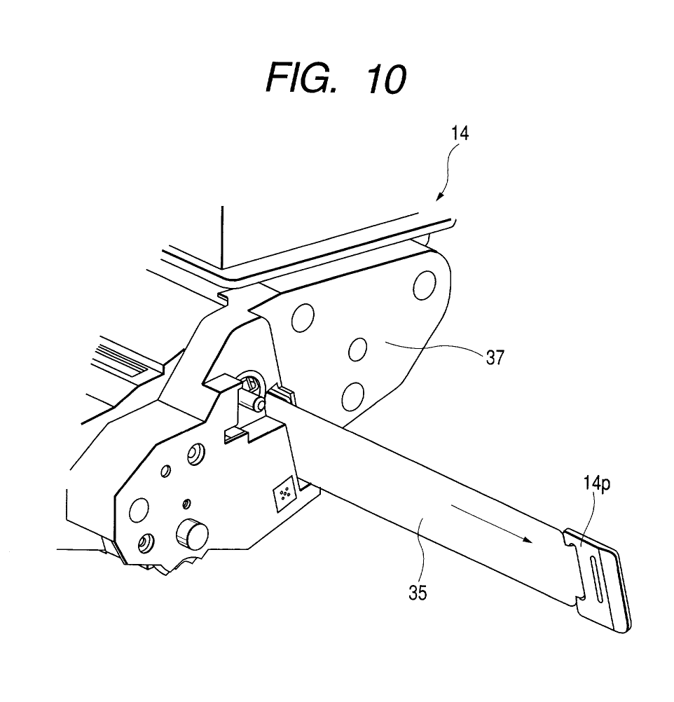

The end portion (a grip end portion) 35b, drawn to the outside, of the seal member 35 is attached to a grip member 14p being a handgrip. The grip member 14p is formed integrally with the developer container 14. The thickness of a connection portion 14q of the grip member 14p for connecting the grip member 14p with the developer container 14 is made to be especially thin to make it possible to tear the grip member 14p off the developer container 14. Moreover, the grip member 14p is bent by about 90 degrees (see FIG. 3) and is packed in order that the whole length of the packed cartridge B becomes shorter and that the packing efficiency is good when the cartridge B is packed. A user raises the grip member 14p and cuts off the grip member 14p at the thin (frangible) connection portion 14q to draw the seal member 35 in the direction indicated by an arrow in FIG. 10. Thereby, the seal member 53 is torn off along the slits 35c, and then the developer feeding opening 14e of the developer container 14 is opened. Then, the developer in the developer container 14 is fed into the developing frame 13 through the developer feeding opening 14e, and it becomes possible to use the cartridge B.

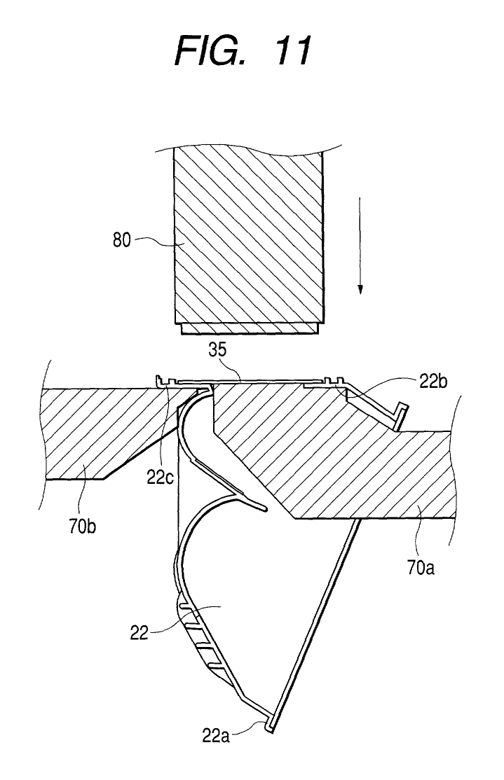

Next, a method of connecting the developing device unit will be described in the order of processes with reference to FIG. 11 to FIG. 13.

(i) Attaching Process of the Seal Member 35 (FIG. 11)

At first, the seal member 35 is attached to the developer feeding opening 14e of the container frame 22 constituting the developer container 14 by hot welding in order to cover the developer feeding opening 14e.

As shown in FIG. 11, the container frame 22 is fixed on a receiving jigs 70a and 70b so that the receiving jigs 70a and 70b hold the wall surface 22b and the flange 22c of the container frame 22, respectively. After that, the seal member 35 is set on the developer feeding opening 14e. In such a state, a hot welding jig 80 is made to descend to press the seal member 35. Then, the hot welding jig 80 melts the hot welding layer (the sealant layer) of the seal member 35 while the hot welding jig 80 makes the seal member 35 closely adhere to the peripheral portions of the developer feeding opening 14e.

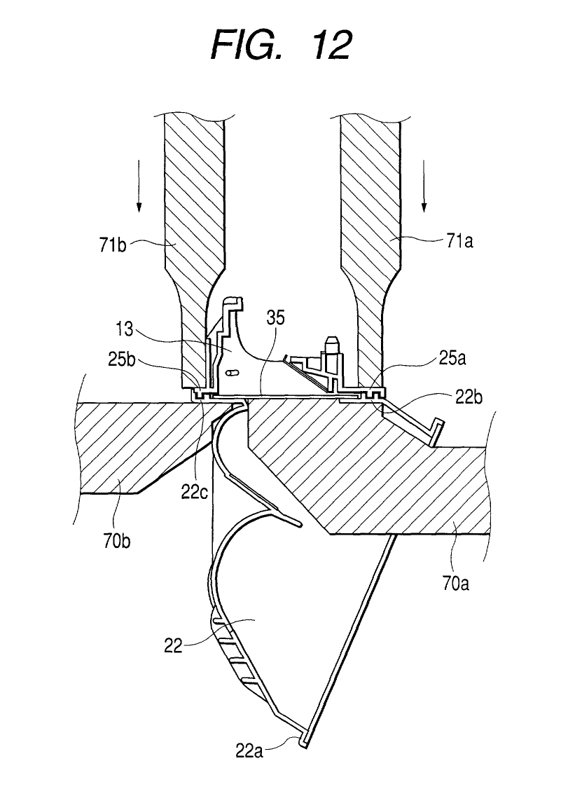

(ii) Connecting Process of the Developing Frame 13 and the Container Frame 22 (FIG. 12)

Next, the developing frame 13 is connected to the container frame 22 with the seal member 35 attached thereto by the ultrasonic welding.

As shown in FIG. 12, after the container frame 22 is fixed by the receiving jigs 70a and 70b so that the wall surface 22b and the flange 22c of the container frame 22 are held by the receiving jigs 70a and 70b, respectively, the developing frame 13 is placed on the fixed container frame 22. At this time, as shown in FIGS. 6A, 6B and 6C in detail, the protruded threads 25c and 25d of the developing frame 13 are respectively fitted into the thread grooves 22f and 22g formed on the wall surface 22b and the flange 22c of the container frame 22, respectively. Then, the welding horns 71a and 71b descend to press the flanges 25a and 25b of the developing frame 13 to the wall face 22b and the flange 22c of the container frame 22, respectively. Then, ultrasonic vibrations are applied to the protruded threads 25c and 25d and the thread grooves 22f and 22g to melt with friction heat the protruded threads 25f and 25g, each of which has a triangular cross section, and which are formed at the end portions of the protruded threads 25c and 25d, respectively, and then the protruded threads 25c and 25d are connected with the bottom portions of the thread grooves 22f and 22g by the welding. Thereby, the upper and the lower edges 22f₁ and 22g₁ of the thread grooves 22f and 22g of the container frame 22 abut against the flanges 25a and 25b of the developing frame 13 so that the container frame 22 and the developing frame 13 are connected with each other. Consequently, as shown in FIG. 6A, a space is formed between the surfaces, which are opposed to each other with a predetermined distance, while the surrounding ribs are closely connected to each other. Then, the seal member 35 is disposed in the space.

In this case, the receiving jigs 70a and 70b receive the same surfaces of the container frame 22 as those in the attaching process of the seal member in the above item (i).

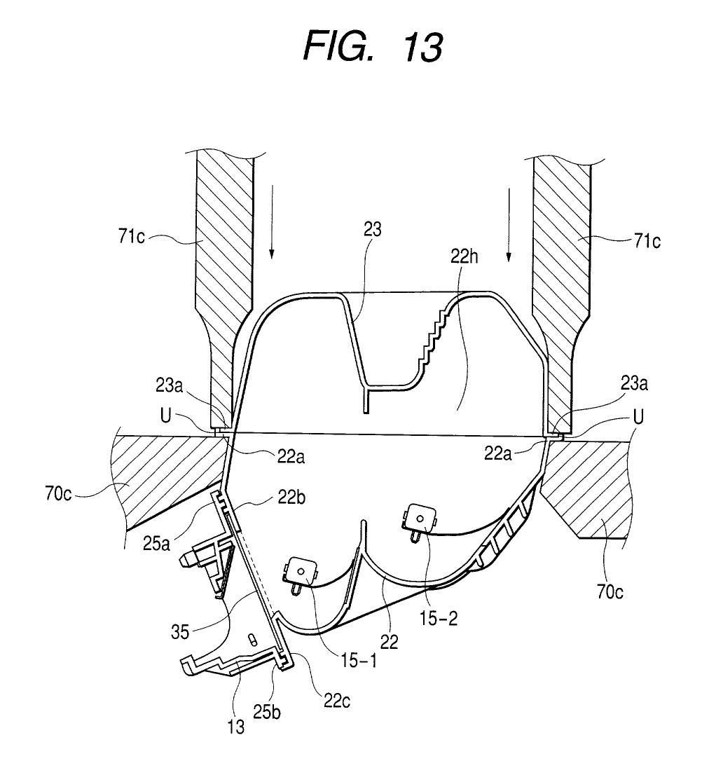

(iii) Connecting Process of Lid Frame 23 (FIG. 13)

Next, the lid frame 23 is connected to the container frame 22, to which the developing frame 13 is connected, by the ultrasonic welding.

As shown in FIG. 13, after the agitating members 15-1 and 15-2 are incorporated into the container frame 22 connected to the developing frame 13, the container frame 22 is fixed on the receiving jig 70c so that the receiving jig 70c receives the entire circumference of the back side of the flange 22a of the welding plane U. Then, the flange 23a of the lid frame 23 is placed on and aligned with the flange 22a of the container frame 22, and the lid frame 23 is fixed on the container frame 22. After that, the welding horn 71c descends and is operated to weld and connect the flange 23a to the flange 22a by the ultrasonic welding. In such a way, the flange 22a of the container frame 22 is fitted to the flange 23a of the lid frame 23. Then, the flanges 22a and 23a are connected together on the welding plane U by melting the welding ribs with the ultrasonic welding so that the frames 22 and 23 are formed into a unitary body in the shape of a container.

The thus connected developer container 14 is filled with developer. And, parts such as the developing roller 11, the developing blade 12 and the like are incorporated into the developing frame 13. Thereby, the developing device unit 19 is completed.

Then, the completed developing device unit 19 and the photosensitive member unit 20 are flanked by the side covers (L) 37 and (R) 38 at the opposed ends thereof and connected integrally into a process cartridge B.

Although the example of the method, which uses the ultrasonic welding, of connecting the frames is described in the aforementioned embodiments, the method of connecting the frames according to the present invention is not limited to the ultrasonic welding. Any method capable of connecting frames may be applied as the method of connecting the frames according the present invention. The frames may be connected by, for example, screwing, hot welding, vibration welding, adhesives, and the like.

Likewise, as for the method of attaching the seal member, the seal member may be effectively attached by adhesion, ultrasonic welding, and the like as the embodiments.

Moreover, although the example, in which the lid frame is connected to the container frame for the formation of the developer container, is described in the embodiments of the present invention, it is not necessary that the lid frame 23 closes the top opening of the container frame 22. Any configuration for connecting a plurality of frames can obtain the similar advantages. As in the embodiments described above, the developer container can increase its containing capacity of developer by being provided with the lid frame. This is because developer can also be contained in the portion of the lid frame.

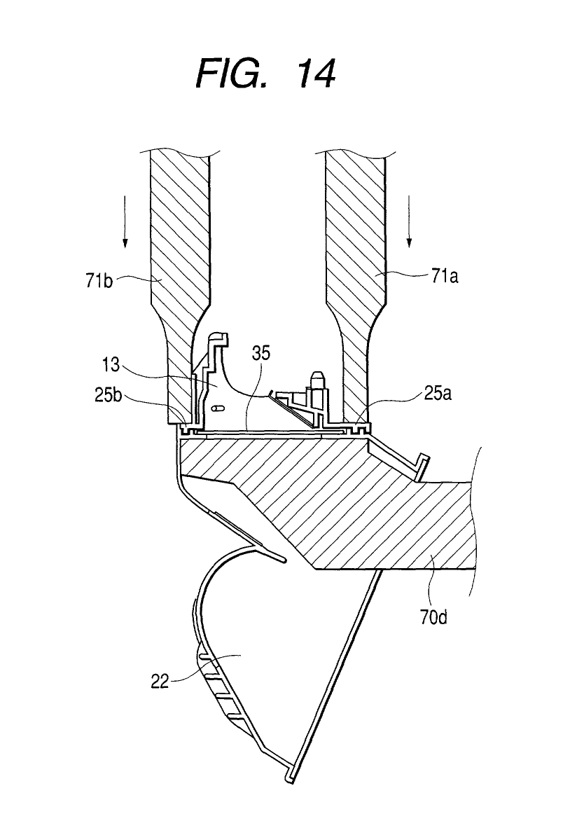

Incidentally, in the embodiments described above, the configuration such that the flange on the upper side of the developer feeding opening 14e of the container frame 22 is removed for providing an additional developer containing space is described. However, the configuration on the opposite side (the lower side) of the developer feeding opening 14e may similarly be configured to remove the flange 22c. In this case, as shown in FIG. 14, the configuration of the container frame 22 is one in which an integral ultrasonic receiving jig 70d is inserted into the container frame through its opening for connecting the lid frame to receive both the connection portions on the inner surfaces of the container frame. Incidentally, if the removal of either or both of the flanges is realized in the container frame, the configuration is included in the scope of the present invention. The reason is that even the removal of either of the flanges can bring about advantages of the present invention. In case of the removal of both the flanges, the further advantages of the present invention can be obtained.

As described above, the present invention adopts the configuration of a developer container that does not need a flange of at least one portion for the connection of a container frame and a developing frame. Thereby, the developer containing space of the developer container can effectively be utilized. Consequently, the capacity of the developer container can be increased without the increase of the sizes of a process cartridge and the main body of an image forming apparatus. That is, the present invention can increase the capacity of the developer container.

While the invention has been described with reference to the structure disclosed herein, it is not confined to the details set forth and this application is intended to cover such modifications or changes as may come within the purposes of the improvements or the scope of the following claims.

What is claimed is:

1. A developer container to be used in a main body of an electrophotographic image forming apparatus, said developer container containing developer to be used for development of an electrostatic latent image formed on an electrophotographic photosensitive member by a developing member, said developer container comprising:
a container frame provided with an opening and a developer feeding opening for feeding the developer to a developing frame, in which said developing member is disposed; and
a lid frame connected to said container frame to close said opening of said container frame,
wherein said container frame has a lid frame connection portion to which said lid frame is connected at a peripheral portion of said opening, and a developing frame connection portion to which said developing frame is connected so that said container frame communicates with said developing frame through said developer feeding opening, and
wherein said lid frame connection portion is located at least on one end side in a widthwise direction of said container frame, and said lid frame connection portion is located outside a plane perpendicular to said developing frame connection portion, the plane passing through an outer end portion in said widthwise direction of said developing frame connection portion provided along a lengthwise direction of said developer feeding opening at an end in said widthwise direction of said developer feeding opening.

2. A developer container according to claim 1, wherein a removable seal member for closing said developer feeding opening is attached to said container frame by a hot welding, and a surface of said container frame for receiving the seal member attached by the hot welding is arranged on substantially the same plane as a surface of said container frame for receiving said developing frame connected to said container frame.

3. A developer container according to claim 1 or 2, wherein said container frame is provided with a container flange formed integrally with said container frame and protruding outward from the peripheral portion of said opening, and said lid frame is provided with a lid flange formed integrally with said lid frame and protruding outward from a peripheral portion of said lid frame, and said lid frame connection portion comprises said container flange and said lid flange.

4. A developer container according to claim 1 or 2, wherein said container frame and said lid frame are connected by a screw, an adhesive, an ultrasonic welding, a hot welding, or a vibration welding.

5. A developer container according to claim 1 or 2, wherein said container frame and said developing frame are connected by a screw, an adhesive, an ultrasonic welding, a hot welding, or a vibration welding.

6. A developing device to be used in a main body of an electrophotographic image forming apparatus, said developing device comprising:
a developing member for developing an electrostatic latent image formed on said electrophotographic photosensitive member with developer;
a developing frame in which said developing member is disposed; and
a developer container for containing the developer, said developer container including a container frame provided with an opening and a developer feeding opening for feeding the developer to said developing frame, and a lid frame connected to said container frame to close said opening of said container frame,
wherein said container frame of said developer container has a lid frame connection portion to which said lid frame is connected at a peripheral portion of said opening, and a developing frame connection portion to which said developing frame is connected so that said container frame communicates with said developing frame through said developer feeding opening, and
wherein said lid frame connection portion is located at least on one end side in a widthwise direction of said container frame, and said lid frame connection portion is located outside a plane perpendicular to said developing frame connection portion, said plane passing through an outer end portion in said widthwise direction of said developing frame connection portion provided along a lengthwise direction of said developer feeding opening at an end in said widthwise direction of said developer feeding opening.

7. A developing device according to claim 6, wherein a removable seal member for closing said developer feeding opening is attached to said container frame by a hot welding, and a surface of said container frame for receiving the seal member attached by the hot welding is arranged on substantially the same plane as a surface of said container frame for receiving said developing frame connected to said container frame.

8. A developing device according to claim 6 or 7, wherein said container frame is provided with a container flange formed integrally with said container frame and protruding outward from the peripheral portion of said opening, and said lid frame is provided with a lid flange formed integrally with said lid frame and protruding outward from a peripheral portion of said lid frame, and said lid frame connection portion comprises said container flange and said lid flange.

9. A developing device according to claim 6 or 7, wherein said container frame and said lid frame are connected by a screw, an adhesive, an ultrasonic welding, a hot welding, or a vibration welding.

10. A developing device according to claim 6 or 7, wherein said container frame and said developing frame are connected by a screw, an adhesive, an ultrasonic welding, a hot welding, or a vibration welding.

11. A process cartridge detachably mountable to a main body of an electrophotographic image forming apparatus, said process cartridge comprising:
an electrophotographic photosensitive member;
a developing member for developing an electrostatic latent image formed on said electrophotographic photosensitive member with developer;
a developing frame in which said developing member is disposed; and
a developer container for containing the developer, said developer container including a container frame provided with an opening and a developer feeding opening for feeding the developer to said developing frame, and a lid frame connected to said container frame to close said opening of said container frame,
wherein said container frame of said developer container has a lid frame connection portion to which said lid frame is connected at a peripheral portion of said opening, and a developing frame connection portion to which said developing frame is connected so that said container frame communicates with said developing frame through said developer feeding opening, and
wherein said lid frame connection portion is located at least on one end side in a widthwise direction of said container frame, and said lid frame connection portion is located outside a plane perpendicular to said developing frame connection portion, said plane passing through an outer end portion in said widthwise direction of said developing frame connection portion provided along a lengthwise direction of said developer feeding opening at an end in said widthwise direction of said developer feeding opening.

12. A process cartridge according to claim 11, wherein a removable seal member for closing said developer feeding opening is attached to said container frame by a hot welding, and a surface of said container frame for receiving the seal member attached by the hot welding is arranged on substantially the same plane as a surface of said container frame for receiving said developing frame connected to said container frame.

13. A process cartridge according to claim 11 or 12, wherein said container frame is provided with a container flange formed integrally with said container frame and protruding outward from the peripheral portion of said opening, and said lid frame is provided with a lid flange formed integrally with said lid frame and protruding outward from a peripheral portion of said lid frame, and said lid frame connection portion comprises said container flange and said lid flange.

14. A process cartridge according to claim 11 or 12, wherein said container frame and said lid frame are connected by a screw, an adhesive, an ultrasonic welding, a hot welding, or a vibration welding.

15. A process cartridge according to claim 11 or 12, wherein said container frame and said developing frame are connected by a screw, an adhesive, an ultrasonic welding, a hot welding, or a vibration welding.

16. An electrophotographic image forming apparatus for forming an image on a recording medium, said electrophotographic image forming apparatus comprising:
(i) a mounting portion for detachably mounting a developing device, said developing device including:
a developing member for developing an electrostatic latent image formed on an electrophotographic photosensitive member with developer;
a developing frame in which said developing member is disposed; and
a developer container for containing the developer, said developer container including a container frame provided with an opening and a developer feeding opening for feeding the developer to said developing frame, and a lid frame connected to said container frame to close said opening of said container frame,
wherein said container frame of said developer container has a lid frame connection portion to which said lid frame is connected at a peripheral portion of said opening, and a developing frame connection portion to which said developing frame is connected so that said container frame communicates with said developing frame through said developer feeding opening, and
wherein said lid frame connection portion is located at least on one end side in a widthwise direction of said container frame, and said lid frame connection portion is located outside a plane perpendicular to said developing frame connection portion, said plane passing through an outer end portion in said widthwise direction of said developing frame connection portion provided along a lengthwise direction of said developer feeding opening at an end in said widthwise direction of said developer feeding opening; and
(ii) a conveying member for conveying the recording medium.

17. An electrophotographic image forming apparatus to which a process cartridge is detachably mountable for forming an image on a recording medium, said electrophotographic image forming apparatus comprising:
(i) a mounting portion for detachably mounting a process cartridge, said process cartridge including:
an electrophotographic photosensitive member;
a developing member for developing an electrostatic latent image formed on said electrophotographic photosensitive member with developer;
a developing frame in which said developing member is disposed; and
a developer container for containing the developer, said developer container including a container frame provided with an opening and a developer feeding opening for feeding the developer to said developing frame, and a lid frame connected to said container frame to close said opening of said container frame,
wherein said container frame of said developer container has a lid frame connection portion to which said lid frame is connected at a peripheral portion of said opening, and a developing frame connection portion to which said developing frame is connected so that said container frame communicates with said developing frame through said developer feeding opening, and
wherein said lid frame connection portion is located at least on one end side in a widthwise direction of said container frame, and said lid frame connection portion is located outside a plane perpendicular to said developing frame connection portion, said plane passing through an outer end portion in said widthwise direction of said developing frame connection portion provided along a lengthwise direction of said developer feeding opening at an end in said widthwise direction of said developer feeding opening; and
(ii) a conveying member for conveying the recording medium.

18. A method of assembling a developer container to be used in an electrophotographic image forming apparatus, said method comprising:
a developing frame connecting step of connecting a container frame to a developing frame by a developing frame connection portion so that said container frame communicates with said developing frame through a developer feeding opening, wherein said container frame is provided with an opening and said developer feeding opening for feeding the developer to said developing frame, in which a developing member is disposed, wherein said container frame has a lid frame connection portion to which a lid frame is connected at a peripheral portion of said opening, and said developing frame connection portion to which said developing frame is connected so that said container frame communicates with said developing frame through said developer feeding opening; and
a lid frame connecting step of connecting said container frame to said lid frame by said lid frame connection portion so that said lid frame closes said opening,
whereby said container frame and said lid frame are connected so that said lid frame connection portion is located at least on one end side in a widthwise direction of said container frame, and said lid frame connection portion is located outside a plane perpendicular to said developing frame connection portion, said plane passing through an outer end portion in said widthwise direction of said developing frame connection portion provided along a lengthwise direction of said developer feeding opening at an end in said widthwise direction of said developer feeding opening.

19. A method of assembling a developer container according to claim 18, comprising:
attaching a removable seal member for closing said developer feeding opening to said container frame by a hot welding before said developing frame connecting step.

20. A method of assembling a developer container according to claim 18 or 19, wherein said lid frame connecting step includes a step of connecting said lid frame to said container frame by a screw, an adhesive, an ultrasonic welding, a hot welding, or a vibration welding.

21. A method of assembling a developer container according to claim 18 or 19, wherein said developing frame connecting step includes a step of connecting said developing frame to said container frame by a screw, an adhesive, an ultrasonic welding, a hot welding, or a vibration welding.

22. A process cartridge according to claim 11, wherein said lid frame connection portion is located on one end side in a widthwise direction of said container frame, and said lid frame connection portion is located outside a plane perpendicular to said developing frame connection portion, said plane passing through an outer end portion in said widthwise direction of said developing frame connection portion provided along a lengthwise direction of said developer feeding opening at the other end in said widthwise direction of said developer feeding opening.
